(19) United States
(12) Patent Application Publication
(10) Pub. No.: US 2024/0221535 A1
(43) Pub. Date: Jul. 4, 2024

(54) Need-Based Generation of Multi-Modal Communication Aids to Aid Verbal Communications

(71) Applicant: AT&T Intellectual Property I, L.P., Atlanta, GA (US)

(72) Inventors: Rashmi Palamadai, Naperville, IL (US); Yupeng Jia, Austin, TX (US)

(73) Assignee: AT&T Intellectual Property I, L.P., Atlanta, GA (US)

(21) Appl. No.: 18/090,644

(22) Filed: Dec. 29, 2022

(51) Int. Cl. G09B 21/00; G10L 15/08

(52) U.S. Cl. CPC G09B 21/00; G10L 15/08; G10L 2015/088

(57) ABSTRACT

Concepts and technologies disclosed herein are directed to need-based generation of multi-modal communication aids to aid verbal communications. According to one aspect disclosed herein, a user system can receive a request for a multi-modal communication aid to be used during a communications session between the user system and an additional user system. The communications session can include live audio and/or live video. The request can be received in response to a technology issue (e.g., poor audio quality) and/or a user issue (e.g., difficulty hearing). In response to the request, the user system can receive a selection of the multi-modal communication aid. The selection can be based upon a pre-defined multi-modal communication aid or a newly-created multi-modal communication aid (e.g., user-created or artificial intelligence-created). The user system can the provide the multi-modal communication aid to the additional user system via the communications service.

### BACKGROUND

Consumers purchase a wide range of products. Many of these products are backed by customer support, which often can be accessible via text-based support such as email, chat, and social media. While some companies only provide customer support through these communications channels, other companies still offer live person-to-person calls during which the consumer can speak directly to another human. Often times, a consumer is asked several questions during a customer support call, and the answers may need to be repeated multiple times for various reasons. For example, the connection quality may limit the ability of the customer support personnel and the consumer to hear each other clearly. The accent of the consumer and/or the customer support personnel also may make it difficult for each party to understand what the other has said. This can lead to frustration by both parties and may make the customer support call less productive than it could be if their communication was not impeded. In addition to the customer use case described above, similar issues may arise in other situations such as virtual meetings and calls among family, friends, colleagues, and/or professionals (e.g., telemedicine).

### SUMMARY

Concepts and technologies disclosed herein are directed to need-based generation of visualizations to aid verbal communications. According to one aspect disclosed herein, a user system can receive a request for a multi-modal communication aid to be used during a communications session between the user system and an additional user system. The communications session can include live audio and/or live video. In some embodiments, the multi-modal communication aid can include an avatar-based visualization superimposed on the live video. The avatar-based visualization can help a user understand what another user is attempting to convey. The request can be received in response to a technology issue (e.g., poor audio quality) and/or a user issue (e.g., difficulty hearing). In response to the request, the user system can receive a selection of the multi-modal communication aid. The selection can be based upon a pre-defined multi-modal communication aid or a newly-created multi-modal communication aid (e.g., user-created or artificial intelligence-created). The user system can then provide the multi-modal communication aid to the additional user system via the communications service.

According to another aspect disclosed herein, a user system can send, during a communications session hosted by a communications service and established between the user system and an additional user system, a request for a multi-modal communication aid to be used. The communications session can include live audio and/or live video. In some embodiments, the request can be generated based upon a profile that includes one or more trigger words and/or phrases. The request can be received in response to a technology issue (e.g., poor audio quality) and/or a user issue (e.g., difficulty hearing). In response to the request, the user system can receive the multi-modal communication aid and present the multi-modal communication aid to a user associated with the user system.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts disclosed herein.

FIG. 2 is a flow diagram illustrating aspects of a method for outputting multi-modal communication aid during a communications session, according to an illustrative embodiment.

FIG. 3 is a flow diagram illustrating aspects of a method for receiving multi-modal communication aid during a communications session, according to an illustrative embodiment.

FIG. 4 is a block diagram illustrating an example computer system and components thereof capable of implementing aspects of the concepts and technologies disclosed herein, according to an illustrative embodiment.

FIG. 5 is a block diagram illustrating an example mobile device and components thereof capable of implementing aspects of the concepts and technologies disclosed herein, according to an illustrative embodiment.

FIG. 6 schematically illustrates a network and components thereof capable of implementing aspects of the concepts and technologies disclosed herein, according to an illustrative embodiment.

FIG. 7 is a diagram illustrating a machine learning system and components thereof capable of implementing aspects of the concepts and technologies disclosed herein, according to an illustrative embodiment.

FIG. 8 is a block diagram illustrating an example virtualized cloud architecture and components thereof capable of implementing aspects of the concepts and technologies disclosed herein, according to an illustrative embodiment.

### DETAILED DESCRIPTION

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

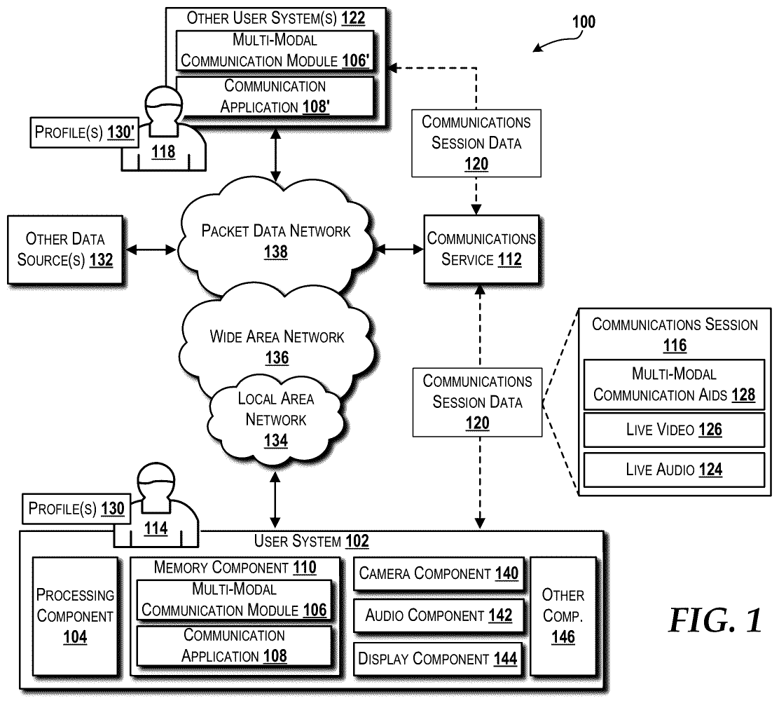

Turning now to FIG. 1, an operating environment 100 in which embodiments of the concepts and technologies disclosed herein will be described. The operating environment 100 includes a user system 102 that includes a processing component 104 to execute instructions for a multi-modal communication module 106 and a communication application 108 stored in a memory component 110. The multi-modal communication module 106 can be separate from or integrated with the communication application 108. The multi-modal communication module 106 can be implemented as an application programming interface (“API”). The multi-modal communication module 106 can be implemented as a plug-in to the communication application 108. Other implementations of the multi-modal communication module 106 are contemplated, and as such, the examples provided herein should not be construed as being limiting in any way.

The communication application 108 can provide client-side functionality for a communications service 112 through which a user 114 associated with the user system 102 can host and/or participate in a communications session 116 with one or more other users 118. The communications service 116 can facilitate the exchange of communications session data 120 among the communication application 108 executed by the user system 102 and a similarly-configured communication application 108′ executed by one or more other user systems 122 associated with the other user(s) 118, each of whom also can be host and/or participate in the communications session 116. As used herein, the term “communications session” broadly encompasses any situation in which the user 114 and one or more of the other users 118 interact via the communications service 112. Accordingly, the communications session 116 can include, but is not limited to, a telephone call between two or more individuals (e.g., a customer support call), a video call between two or more individuals (e.g., a telemedicine call), an accessibility communications session (e.g., a deaf/reduced hearing user, a blind/reduced sight user, a color blind user, a non-native language speaking user, or the like), an education communications session, a virtual gathering of friends and/or family, a work meeting, a social meeting, or the like. The communications session data 120 can refer to the audio, video, text, and any other data associated with the communications session 116.

In the illustrated example, the communications session 116 includes live audio 124 and may include live video 126. The live audio 124 can include spoken words from the user 114 and the other user(s) 118 during the communications session 116. For various reasons, the live audio 124 may be difficult or impossible for the user 114 and/or the other user(s) 118 to hear properly. This may be due to a technology issue such as poor sound quality or low volume. This may be due to a user issue such as the user 114 speaking in a particularly difficult to understand accent for the other user(s) 118 or vice versa. It should be understood that other technology and/or user issues that reduce the ability of the user 114 and/or the other user(s) 118 to hear properly the words spoken during the communications session 116 are contemplated.

From time-to-time during the communications session 116, the user 114 and/or the other user(s) 118 may need assistance in understanding what is being said. As such, the multi-modal communication module 106 can introduce one or more multi-modal communication aids 128 into the communications session 116 to provide assistance via another method of communication. The multi-modal communication aid 128 can provide a visualization to express what is being said. The visualization can include text or images. For example, in a situation where the user 114 may need assistance from customer support (e.g., the other user 118) to see what the customer support personnel is saying or vice-versa (e.g., customer support needs to see what the customer is saying, especially if it is a complex/difficult name, concept, address, or phone number), the multi-modal communication aid 128 would allow the user 114 or customer support personnel (e.g., the other user 118) to present a visualization of what is being said. This would assist the user 114 to see clearly what is being said. Also, use of the multi-modal communication aids 128 can help confirm what the users 114/118 have said to each other to assist with each other's understanding. Similarly, if the user 114/118 is having problems hearing or seeing, the multi-modal communication aids 128 can be used to share the concept/what is being said. As another example, in a situation where there is a large/multi-modal conference/meeting, the users 114/118 may need assistance understanding or remembering how they can connect with other attendees. Prior to the communications session 116, the multi-modal communication aids 128 can provide that assistance.

The multi-modal communication aid 128 can include an avatar-based visualization superimposed on the live video 126. The multi-modal communication aid 128 can include an avatar-based visualization superimposed on the live video 126. For example, if the communications session 116 is a customer care call, and the customer needs to pull out a wire from the back of a device, the multi-modal communication aid 128 could show an avatar pointing to and pulling out the specific wire. As another example, if within a metaspace, the multi-modal communication aid 128 could show an avatar performing specific actions. Similarly, a medical professional can demonstrate how to use a specific medical tool correctly, and the user can follow along during a virtual telemedicine appointment. Once the avatar performs that action, the reaction to the body can be depicted as well so that the user/patient understands visually what is going to happen. The avatars and actions can be depicted in virtual reality, augmented reality, and mixed reality modes.

In some embodiments, the users 114/118 can have one or more profiles 130/130′, such as personal, professional, and/or social profiles. The profile(s) 130/130′ can provide a context for the users 114/118 in a given communications session 116 (e.g., personal, professional, and/or social context). The profile(s) 130/130′ can contain specific multi-modal communication aids 128 to be used during the communications session 116. In some embodiments, the multi-modal communication aids 128 in the profile(s) 130/130′ can be pre-determined. In other embodiments, the multi-modal communication aids 128 in the profile(s) 130/130′ can be dynamically updated during the communications session 116 (e.g., either to the active profile, other available profiles, or both). The profile(s) 130/130′ can contain trigger words that, when used during the communications session 116, prompt the multi-modal communication aid(s) 128 to be presented automatically.

In some embodiments, the user 114 and/or the other user(s) 118 can define a title, subject matter area, capabilities, certifications, education, company name, and/or other information relevant to a given communications session 116 (e.g., some of which may be particular to a virtual work meeting) during session setup. The user 114 and/or other user(s) 118 also can choose a type of multi-modal communication aids 128 to be used during the communications session 116. In some embodiments, the multi-modal communication aids 128 can be based upon external data such as provided during session setup and/or other data obtained from other data sources 132. For example, the other data source 132 can store a contact list (e.g., a corporate email list) associated with an email account of the user 114. The user system 102 can pull the contact list from the other data source 132 and use this information to identify the other users 118 in the communications session 116 using the multi-modal communication aids 128. Additional information such as varying degrees of how well the user 114 knows the other users 118 can be provided as well. Artificial intelligence can be used to identify the other user(s) 118. The other user(s) 118 may choose to opt-out of this functionality.

In some embodiments, the multi-modal communication aids 128 can be determined based upon the specific needs of the user 114. For example, if the user 114 is deaf/has reduced hearing, the multi-modal communication aids 128 can include a pop-up visualization, such as an avatar of the other user(s) 118, that can lip sync with the live audio 124, which can allow the user 114 to lipread instead of relying on hearing. As another example, if the user 114 is blind/has reduced sight, the multi-modal communication aids 128 can include supplemental feedback through 3D braille via a haptic glove. The multi-modal communication aids 128 also can aid the user 114 if he or she does not speak English (or other commonly spoken language in a given location) by providing images to communicate (e.g., showing an image descriptive of a specific word). The multi-modal communication aids 128 can include visual support to aid the user 114 if he or she is color blind.

In the illustrated example, the user system 102 is operating in communication with a local area network (“LAN”) 134, which may be embodied as a wireless LAN (“WLAN”) or a wired LAN. The LAN 134 may be a home WI-FI network of the user 114, for example. Alternatively, the LAN 134 may be another WI-FI network associated with another location in which the user 114 is remotely working via the user system 102. The LAN 134 can operate in communication with a wide area network (“WAN”) 136. The WAN 136 can be provided by one or more Internet service providers (“ISPs”) to facilitate connectivity between LANs (e.g., the LAN 134) and a packet data network (“PDN”) 138 (e.g., the Internet). The WAN 136 can be a wireless WAN (“WWAN”) provided by a mobile service provider. The other user system(s) 122 and the other data source(s) 132 are shown operating in direct communication with the PDN 138. Those skilled in the art will appreciate that the other user system(s) 122 and the other data source(s) 132 may access the PDN 138 through one or more LANs (similar to the LAN 134) and one or more WANs (similar to or the same as the WAN 136). It should be understood that, in some instances, the user system 102, the other user system(s) 122, the other data source(s) 132, or a combination thereof may operate in communication with the same network(s).

Returning to the user system 102, the processing component 104 can include a central processing unit (“CPU”) configured to process data, execute computer-executable instructions of one or more application programs (e.g., the multi-modal communication module 106 and the communication application 108), and communicate with other components of the user system 102 in order to perform various functionality described herein. In some embodiments, the processing component 104 includes a graphics processing unit (“GPU”) configured to accelerate operations performed by the CPU, including, but not limited to, execution of general-purpose scientific and engineering computing applications, as well as graphics-intensive computing applications such as high resolution video (e.g., 480i/p, 720i/p, 1080i/p, 4K, 8K, and greater resolutions), video games, three-dimensional modeling applications, and the like. In some embodiments, the processing component 104 can communicate with a discrete GPU (not shown). In any case, the CPU and GPU can be configured in accordance with a co-processing CPU/GPU computing model, wherein the sequential part of an application executes on the CPU and the computationally-intensive part, such as the generation and presentation of video, graphics, and other aspects of the multi-modal communication aids 128, is accelerated by the GPU. In some embodiments, the processing component 104 is, or is included in, a system-on-chip (“SoC”) along with one or more of the other components described herein below. For example, the SoC can include the processing component 104 and the memory component 110. In some embodiments, the processing component 104 is fabricated, in part, utilizing a package-on-package (“POP”) integrated circuit packaging technique. Moreover, the processing component 104 can be a single core or multi-core processor. The processing component 104 can be created in accordance with an ARM architecture, available for license from ARM HOLDINGS of Cambridge, United Kingdom. Alternatively, the processing component 104 can be created in accordance with an x86 architecture, such as is available from INTEL CORPORATION of Mountain View, California and others. In some embodiments, the processing component 104 is a SNAPDRAGON SoC, available from QUALCOMM of San Diego, California, a TEGRA SoC, available from NVIDIA of Santa Clara, California, a HUMMINGBIRD SoC, available from SAMSUNG of Seoul, South Korea, an Open Multimedia Application Platform (“OMAP”) SoC, available from TEXAS INSTRUMENTS of Dallas, Texas, a customized version of any of the above SoCs, or a proprietary SoC.

The memory component 110 can include random access memory (“RAM”), read-only memory (“ROM”), integrated storage memory, removable storage memory, or any combination thereof. In some embodiments, at least a portion of the memory component 110 is integrated with the processing component 104. In some embodiments, the memory component 110 is configured to store a firmware, an operating system or a portion thereof (e.g., operating system kernel), one or more applications (e.g., the multi-modal communication module 106 and the communication application 108), and/or a bootloader to load an operating system kernel. Integrated storage memory can include a solid-state memory, a hard disk, or a combination of solid-state memory and a hard disk. The integrated storage memory can be soldered or otherwise connected to a logic board upon which the processing component 104 and other components described herein also may be connected. The integrated storage memory can store an operating system or portions thereof, application programs, data, and other software components described herein. Removable storage memory can include a solid-state memory, a hard disk, or a combination of solid-state memory and a hard disk. In some embodiments, the removable storage memory is provided in lieu of the integrated storage memory. In other embodiments, the removable storage memory is provided as additional optional storage. In some embodiments, the removable storage memory is logically combined with the integrated storage memory such that the total available storage is made available and shown to a user as a total combined capacity. The removable storage memory can be inserted into a removable storage memory slot (not shown) or other mechanism by which the removable storage memory is inserted and secured to facilitate a connection over which the removable storage memory can communicate with other components of the user system 102, such as the processing component 104. The removable storage memory can be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like. It should be understood that the memory component 110 can store an operating system. According to various embodiments, the operating system includes, but is not limited to, LINUX, WINDOWS from Microsoft Corporation, OSX or IOS from Apple Inc., or ANDROID OS from Google Inc. Other operating systems are contemplated.

The illustrated user system 102 also includes a camera component 140 that can be used to capture the live video 126 of the user 114 for the communications session 116. The camera component 140 can include an internal camera component of the user system 102. For example, the user system 102 may be a laptop computer that includes an integrated web camera. Alternatively, the camera component 140 can be built-in to another component of the user system 102, such as a display component 144 (described below). The camera component 140 alternatively can be a standalone camera component such as a standalone web camera.

The user system 102 also includes an audio component 142 that can be used to capture the live audio 124 for the user 114 during the communications session 116. As such, the audio component 142 can include one or more speakers for the output of at least a portion of the live audio 124 to be heard by the user 114 (e.g., audio generated by the other user(s) 118) and one or more microphones for the collection and/or input of audio signals to be heard by the other user(s) 118 (e.g., audio generated by the user 114). The user system 102 also can output the audio feedback that is part of the multi-modal communication aids 128 (e.g., alternative language translation).

The user system 102 can output the live video 126 via a display component 144. The user system 102 also can output the visualizations that are part of the multi-modal communication aids 128. The display component 144 can be or can include one or more monitors, televisions, projectors, virtual reality (“VR”) headsets, augmented reality (“AR”) headsets, mixed reality headsets, and/or other display devices. The display component 144 can be standalone and connected to the user system 102 via a video cable such as high definition media interface (“HDMI”) or DisplayPort. The display component 144 alternatively can be integrated into the user system 102 (e.g., a laptop with an integrated display).

The user system 102 also includes one or more other components 146 that can be used to implement the multi-modal communication aids 128 during the communications session 116. For example, the other component 146 can include a haptic device such as a haptic glove to enable 3D braille for vision impaired users.

The format of the live video 126 and the live audio 124 can be selected based on the needs of a given implementation. As one non-limiting example, the live video 126 and the live audio 124 may be recorded in MPEG-4 Part 14 (“MP4”), although other file formats are contemplated. A recording of the live video 126 and the live audio 124 can be stored locally on the user system 102 and/or the other user system(s) 122 and/or remotely by the communications service 112 (e.g., in cloud-based storage). The recording may be stored temporarily or permanently. The communications session data 120 can include the recording as well as multi-modal communication aids 128 used during the communications session 116. It should be understood that the quality of the live video 126 and the live audio 124 may vary due to the capabilities of the user system 102, the other user system(s) 122, the communications service 112, connectivity to the various networks 134/136/138, and/or for other reasons. As such, audio and video settings such as resolution, bitrate, sampling rate, and the like may be set as needed to accommodate various implementations.

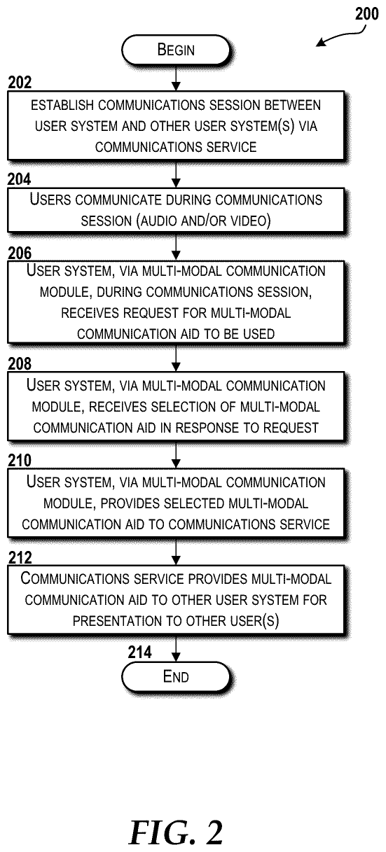

Turning now to FIG. 2, a flow diagram illustrating aspects of a method 200 for outputting multi-modal communication aid during a communications session will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as, for example, the processing component 104 of the user system 102 or similar of the other user system(s) 122, to perform one or more operations, and/or causing the processor to direct other components of the computing system or device to perform one or more of the operations.

For purposes of illustrating and describing the concepts of the present disclosure, operations of the methods disclosed herein are described as being performed by alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 begins and proceeds to operation 202. At operation 202, the communications session 116 can be established between the user system 102 and the other user system(s) 122 via the communications service 112 over one or more of the networks 134/136/138. For ease of explanation, the communications session 116 will be described as being conducted between two individuals—the user 114 and the other user 118. Moreover, the circumstances of the communications session 116 may vary, such as being a customer support call, a telemedicine video call, a work meeting, or other communications session type disclosed herein, and may use live audio 124 and/or live video 126. As such, the method 200 should not be construed as being limiting to any specific communications session type.

From operation 202, the method 200 proceeds to operation 204. At operation 204, the users 114/118 communicate during the communications session 116. The live audio 124 can include spoken words from the user 114 and the other user 118 during the communications session 116. For various reasons, the live audio 124 may be difficult or impossible for either party to hear properly. This may be due to a technology issue such as poor sound quality or low volume. This may be due to a user issue such as the user 114 speaking in a particularly difficult to understand accent for the other user 118 to understand. It should be understood that other technology and/or user issues that reduce the ability of the other user 118 to hear properly the words spoken during the communications session 116 are contemplated.

From operation 204, the method 200 proceeds to operation 206. At operation 206, the user system 102, via execution of the multi-modal communication module 106, during the communications session 116, receives a request for a multi-modal communication aid 128 to be used. The request originates from the other user 118, via the multi-modal communication module 106′, and is sent to the communications service 112, which forwards the request to the user system 102 for presentation to the user 114. The request can identify what the other user 118 is having difficulty understanding. In some embodiments, the request specifies a desired format of the multi-modal communication aid 128 to be used.

From operation 206, the method 200 proceeds to operation 208. At operation 208, the user system 102, via the multi-modal communication module 106, receives a selection of one or more multi-modal communication aids 128 to aid the other user 118 in understanding what is being communicated during the communications session 116. In some embodiments, the user 114 can provide the selection based upon pre-defined multi-modal communication aids 128 or can create a multi-modal communication aid 128 on-the-fly (e.g., draw a picture to illustrated what is being said). In other embodiments, the multi-modal communication module 106 can select the multi-modal communication aid(s) 128 automatically based upon, for example, an artificial intelligence decision made by the multi-modal communication module 106.

From operation 208, the method 200 proceeds to operation 210. At operation 210, the user system 102, via the multi-modal communication module 106, provides the selected multi-modal communication aid(s) 128 to the communications service 112. From operation 210, the method 200 proceeds to operation 212. At operation 212, the communications service 112 provides the multi-modal communication aid(s) 128 to the other user system 122 for presentation to the other user 118.

From operation 212, the method 200 proceeds to operation 214. The method 200 can end at operation 214.

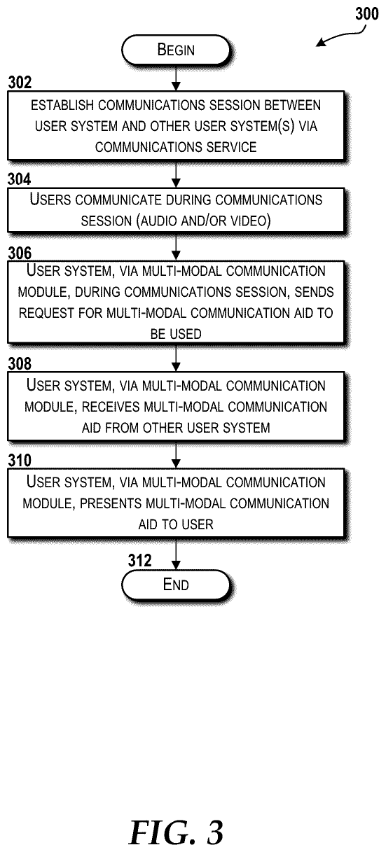

Turning now to FIG. 3, a method 300 for receiving multi-modal communication aid during a communications session will be described, according to an illustrative embodiment. The method 300 begins and proceeds to operation 302. At operation 302, the communications session 116 can be established between the user system 102 and the other user system(s) 122 via the communications service 112 over one or more of the networks 134/136/138. For ease of explanation, the communications session 116 will be described as being conducted between two individuals—the user 114 and the other user 118. Moreover, the circumstances of the communications session 116 may vary, such as being a customer support call, a telemedicine video call, a work meeting, or other communications session type disclosed herein, and may use live audio 124 and/or live video 126. As such, the method 300 should not be construed as being limiting to any specific communications session type.

From operation 302, the method 300 proceeds to operation 304. At operation 304, the users 114/118 communicate during the communications session 116. The live audio 124 can include spoken words from the user 114 and the other user 118 during the communications session 116. For various reasons, the live audio 124 may be difficult or impossible for either party to hear properly. This may be due to a technology issue such as poor sound quality or low volume. This may be due to a user issue such as the other user 118 speaking in a particularly difficult to understand accent for the user 114 to understand. It should be understood that other technology and/or user issues that reduce the ability of the user 114 to hear properly the words spoken during the communications session 116 are contemplated.

From operation 304, the method 300 proceeds to operation 306. At operation 306, the user system 102, via execution of the multi-modal communication module 106, during the communications session 116, sends a request for a multi-modal communication aid 128 to be used. In some embodiments, the user 114 can submit the request via the communication application 108, directly via the multi-modal communication module 106, or via another application that utilizes the multi-modal communication module 106 (e.g., via an API exposed by the multi-modal communication module 106). In some embodiments, the user 114 can submit the request via a soft button on a graphical user interface (“GUI”). In other embodiments, the user 114 can submit the request via a hardware button, which may be programmable or a dedicated button. In other embodiments, the request is generated automatically based upon the profile 130 of the user 114. The profile 130 can contain trigger words or phrases. The multi-modal communication module 106 can recognize the trigger words or phrases during the communications session 116 and automatically generate the request.

From operation 306, the method 300 proceeds to operation 308. At operation 308, the user system 102, via the multi-modal communication module 106, receives the requested multi-modal communication aid(s) 128 from the other user system 122. From operation 308, the method 300 proceeds to operation 310. At operation 310, the user system 102, via the multi-modal communication module 106, presents the multi-modal communication aid 128 to the user 114.

From operation 310, the method 300 proceeds to operation 312. The method 300 can end at operation 312.

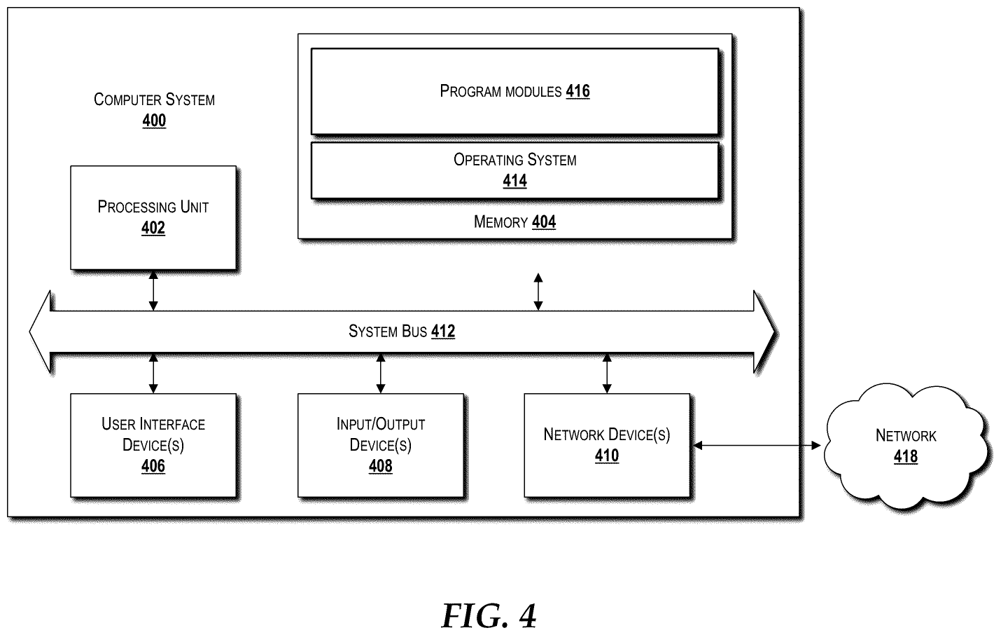

Turning now to FIG. 4, a block diagram illustrating a computer system 400 will be described, according to an illustrative embodiment. In some embodiments, the user system 102 is configured the same as or similar to the computer system 400. In some embodiments, the other user system(s) 122 is/are configured the same as or similar to the computer system 400. The computer system 400 includes a processing unit 402, a memory 404, one or more user interface devices 406, one or more input/output (“I/O”) devices 408, and one or more network devices 410, each of which is operatively connected to a system bus 412. The bus 412 enables bi-directional communication between the processing unit 402, the memory 404, the user interface devices 406, the I/O devices 408, and the network devices 410.

The processing unit 402 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 402 can be a single processing unit or a multiple processing unit that includes more than one processing component. In some embodiments, the processing unit 402 is or includes the processing component 104 (shown in FIG. 1).

The memory 404 communicates with the processing unit 402 via the system bus 412. The memory 404 can include a single memory component or multiple memory components. In some embodiments, the memory 404 is operatively connected to a memory controller (not shown) that enables communication with the processing unit 402 via the system bus 412. The memory 404 includes an operating system 414 and one or more program modules 416. The operating system 414 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or OSX families of operating systems from APPLE CORPORATION, the FREEBSD family of operating systems, the SOLARIS family of operating systems from ORACLE CORPORATION, other operating systems, and the like. In some embodiments, the memory 404 is or includes the memory component 110 (also shown in FIG. 1).

The program modules 416 may include various software and/or program modules described herein. In some embodiments, for example, the program modules 416 can include the multi-modal communication module 106, the communication application 108, or both. In some embodiments, multiple implementations of the computer system 400 can be used, wherein each implementation is configured to execute one or more of the program modules 416. The program modules 416 and/or other programs can be embodied in computer-readable media containing instructions that, when executed by the processing unit 402, perform the methods 200, 300 described herein. According to embodiments, the program modules 416 may be embodied in hardware, software, firmware, or any combination thereof. Although not shown in FIG. 4, it should be understood that the memory 404 also can be configured to store, at least temporarily, the live audio 124, the live video 126, the multi-modal communication aid(s) 128, combinations thereof, and/or other data disclosed herein.

By way of example, and not limitation, computer-readable media may include any available computer storage media or communication media that can be accessed by the computer system 400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 400. In the claims, the phrase “computer storage medium,” “computer-readable storage medium,” and variations thereof does not include waves or signals per se and/or communication media, and therefore should be construed as being directed to “non-transitory” media only.

The user interface devices 406 may include one or more devices with which a user accesses the computer system 400. The user interface devices 406 may include, but are not limited to, computers, servers, personal digital assistants, cellular phones, or any suitable computing devices. The I/O devices 408 enable a user to interface with the program modules 416. In one embodiment, the I/O devices 408 are operatively connected to an I/O controller (not shown) that enables communication with the processing unit 402 via the system bus 412. The I/O devices 408 may include one or more input devices, such as, but not limited to, a keyboard, a mouse, an electronic stylus, the camera component 140, and/or the audio component 142 (particularly a microphone). Further, the I/O devices 408 may include one or more output devices, such as, but not limited to, the display component 144.

The network devices 410 enable the computer system 400 to communicate with other networks or remote systems via a network 418. Examples of the network devices 410 include, but are not limited to, a modem, a radio frequency (“RF”) or infrared (“IR”) transceiver, a telephonic interface, a bridge, a router, or a network card. The network 418 may include a wireless network such as, but not limited to, a WLAN (e.g., the LAN 134) such as a WI-FI network, a Wireless Wide Area Network (“WWAN”) (e.g., the WAN 136), a Wireless Personal Area Network (“WPAN”) such as BLUETOOTH, a Wireless Metropolitan Area Network (“WMAN”) such a WiMAX network, the packet data network 138, a cellular network, or some combination thereof. Alternatively, the network 418 may be a wired network such as, but not limited to, a WAN, LAN, a wired Personal Area Network (“PAN”), or a wired Metropolitan Area Network (“MAN”).

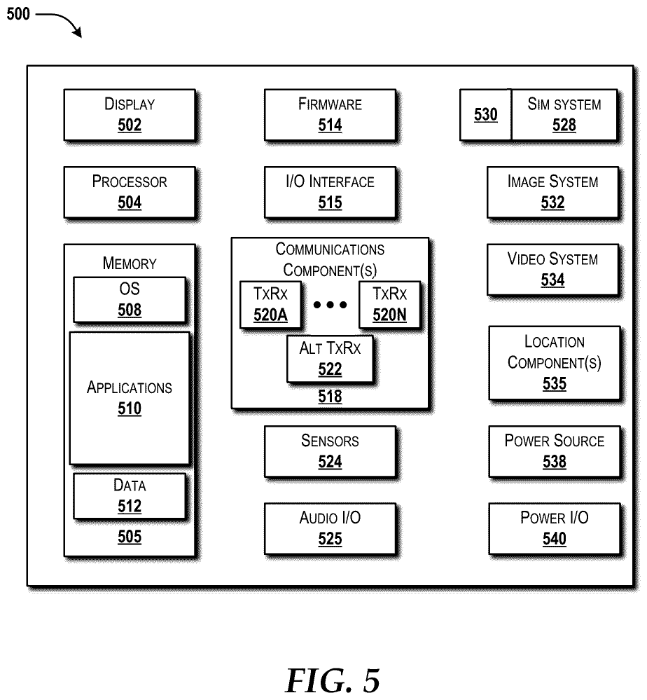

Turning now to FIG. 5, an illustrative mobile device 500 and components thereof will be described. In some embodiments, the user system 102 is configured the same as or similar to the mobile device 500. In some embodiments, the other user system(s) 122 is/are configured the same as or similar to the mobile device 500. While connections are not shown between the various components illustrated in FIG. 5, it should be understood that some, none, or all of the components illustrated in FIG. 5 can be configured to interact with one another to carry out various device functions. In some embodiments, the components are arranged so as to communicate via one or more busses (not shown). Thus, it should be understood that FIG. 5 and the following description are intended to provide a general understanding of a suitable environment in which various aspects of embodiments can be implemented, and should not be construed as being limiting in any way.

As illustrated in FIG. 5, the mobile device 500 can include a display 502 for displaying data. In some embodiments, the display 502 is or includes the display component 144. According to various embodiments, the display 502 can be configured to display the live video 126, the multi-modal communication aid(s) 128, various GUI elements (e.g., for the communication application 108 and the multi-modal communication module 106), text, images, video, virtual keypads and/or keyboards, messaging data, notification messages, metadata, Internet content, device status, time, date, calendar data, device preferences, map and location data, combinations thereof, and/or the like. The mobile device 500 also can include a processor 504 and a memory or other data storage device (“memory”) 506. The processor 504 can be configured to process data and/or can execute computer-executable instructions stored in the memory 506. The computer-executable instructions executed by the processor 504 can include, for example, an operating system 508, one or more applications 510 (e.g., the multi-modal communication module 106 and the communication application 108), other computer-executable instructions stored in the memory 506, or the like. In some embodiments, the applications 510 also can include a UI application (not illustrated in FIG. 5). In some embodiments, the processor 504 is or includes the processing component and the memory 506 is or includes the memory component 110.

The UI application can interface with the operating system 508 to facilitate user interaction with functionality and/or data stored at the mobile device 500 and/or stored elsewhere. In some embodiments, the operating system 508 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 504 to aid a user in entering/deleting data, entering and setting user IDs and passwords for device access, configuring settings, manipulating content and/or settings, multimode interaction, interacting with other applications 510 (e.g., the multi-modal communication module 106 and the communication application 108), and otherwise facilitating user interaction with the operating system 508, the applications 510, and/or other types or instances of data 512 that can be stored at the mobile device 500.

The applications 510, the data 512, and/or portions thereof can be stored in the memory 506 and/or in a firmware 514, and can be executed by the processor 504. The firmware 514 also can store code for execution during device power up and power down operations. It can be appreciated that the firmware 514 can be stored in a volatile or non-volatile data storage device including, but not limited to, the memory 506 and/or a portion thereof.

The mobile device 500 also can include an input/output (“I/O”) interface 516. The I/O interface 516 can be configured to support the input/output of data such as location information, presence status information, user IDs, passwords, and application initiation (start-up) requests. In some embodiments, the I/O interface 516 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 500 can be configured to synchronize with another device to transfer content to and/or from the mobile device 500. In some embodiments, the mobile device 500 can be configured to receive updates to one or more of the applications 510 via the I/O interface 516, though this is not necessarily the case. In some embodiments, the I/O interface 516 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 516 may be used for communications between the mobile device 500 and a network device or local device.

The mobile device 500 also can include a communications component 518. The communications component 518 can be configured to interface with the processor 504 to facilitate wired and/or wireless communications with one or more networks, such as the LAN 134, the WAN 136, and/or the PDN 138 (shown in FIG. 1). In some embodiments, the communications component 518 includes a multimode communications subsystem for facilitating communications via the cellular network and one or more other networks.

The communications component 518, in some embodiments, includes one or more transceivers. The one or more transceivers, if included, can be configured to communicate over the same and/or different wireless technology standards with respect to one another. For example, in some embodiments, one or more of the transceivers of the communications component 518 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 518 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 518 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 518 can include a first transceiver (“TxRx”) 520A that can operate in a first communications mode (e.g., GSM). The communications component 518 also can include an Nth transceiver (“TxRx”) 520N that can operate in a second communications mode relative to the first transceiver 520A (e.g., UMTS). While two transceivers 520A-520N (hereinafter collectively and/or generically referred to as “transceivers 520”) are shown in FIG. 5, it should be appreciated that less than two, two, and/or more than two transceivers 520 can be included in the communications component 518.

The communications component 518 also can include an alternative transceiver (“Alt TxRx”) 522 for supporting other types and/or standards of communications. According to various contemplated embodiments, the alternative transceiver 522 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 518 also can facilitate reception from terrestrial radio networks, digital satellite radio networks, internet-based radio service networks, combinations thereof, and the like. The communications component 518 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 500 also can include one or more sensors 524. The sensors 524 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 500 may be provided by an audio I/O component 526. The audio I/O component 526 of the mobile device 500 can include one or more speakers for the output of audio signals, one or more microphones for the collection and/or input of audio signals, and/or other audio input and/or output devices. In some embodiments, the audio I/O component 526 is or includes the audio component 142 (shown in FIG. 1).

The illustrated mobile device 500 also can include a subscriber identity module (“SIM”) system 528. The SIM system 528 can include a universal SIM (“USIM”), a universal integrated circuit card (“UICC”) and/or other identity devices. The SIM system 528 can include and/or can be connected to or inserted into an interface such as a slot interface 530. In some embodiments, the slot interface 530 can be configured to accept insertion of other identity cards or modules for accessing various types of networks. Additionally, or alternatively, the slot interface 530 can be configured to accept multiple subscriber identity cards. Because other devices and/or modules for identifying users and/or the mobile device 500 are contemplated, it should be understood that these embodiments are illustrative, and should not be construed as being limiting in any way.

The mobile device 500 also can include an image capture and processing system 532 (“image system”). The image system 532 can be configured to capture or otherwise obtain photos, videos, and/or other visual information. As such, the image system 532 can include cameras, lenses, charge-coupled devices (“CCDs”), combinations thereof, or the like. The mobile device 500 may also include a video system 534. The video system 534 can be configured to capture, process, record, modify, and/or store video content such as the live video 126. In some embodiments, the video system 534 is or includes the camera component 140.

The mobile device 500 also can include one or more location components 536. The location components 536 can be configured to send and/or receive signals to determine a geographic location of the mobile device 500. According to various embodiments, the location components 536 can send and/or receive signals from global positioning system (“GPS”) devices, assisted-GPS (“A-GPS”) devices, WI-FI/WIMAX and/or cellular network triangulation data, combinations thereof, and the like. The location component 536 also can be configured to communicate with the communications component 518 to retrieve triangulation data for determining a location of the mobile device 500. In some embodiments, the location component 536 can interface with cellular network nodes, telephone lines, satellites, location transmitters and/or beacons, wireless network transmitters and receivers, combinations thereof, and the like. In some embodiments, the location component 536 can include and/or can communicate with one or more of the sensors 524 such as a compass, an accelerometer, and/or a gyroscope to determine the orientation of the mobile device 500. Using the location component 536, the mobile device 500 can generate and/or receive data to identify its geographic location, or to transmit data used by other devices to determine the location of the mobile device 500. The location component 536 may include multiple components for determining the location and/or orientation of the mobile device 500.

The illustrated mobile device 500 also can include a power source 538. The power source 538 can include one or more batteries, power supplies, power cells, and/or other power subsystems including alternating current (“AC”) and/or direct current (“DC”) power devices. The power source 538 also can interface with an external power system or charging equipment via a power I/O component 540. Because the mobile device 500 can include additional and/or alternative components, the above embodiment should be understood as being illustrative of one possible operating environment for various embodiments of the concepts and technologies described herein. The described embodiment of the mobile device 500 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 500 or other devices or computers described herein, such as the computer system 400 described above with reference to FIG. 4

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 500 in order to store and execute the software components presented herein. It is also contemplated that the mobile device 500 may not include all of the components shown in FIG. 5, may include other components that are not explicitly shown in FIG. 5, or may utilize an architecture completely different than that shown in FIG. 5.

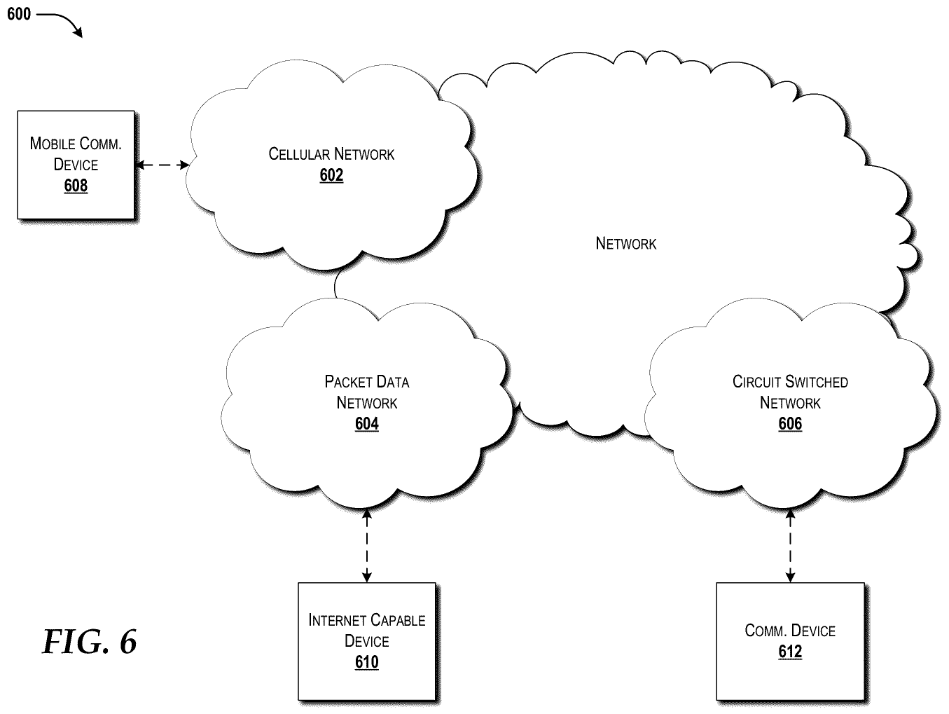

Turning now to FIG. 6, details of a network 600 are illustrated, according to an illustrative embodiment. The network 600 includes a cellular network 602, a packet data network 604, and a circuit switched network 606. In some embodiments, the network 600 is or includes the other networks disclosed herein, including the LAN 134, the WAN 136, the PDN 138, and/or the network 418. As such, the user system 102, the other user system(s) 122, and the communications service 112 via the network 600 to exchange the communications session data 120 in accordance with embodiments disclosed herein.

The cellular network 602 can include various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 602 also includes radios and nodes for receiving and transmitting voice, data, and combinations thereof to and from radio transceivers, networks, the packet data network 604, and the circuit switched network 606.

A mobile communications device 608, such as, for example, a cellular telephone, a user equipment, a mobile terminal, a PDA, a laptop computer, a handheld computer, and combinations thereof, can be operatively connected to the cellular network 602. The mobile communications device 608 can be configured similar to or the same as the mobile device 500 described above with reference to FIG. 5.

The cellular network 602 can be configured as a GSM network and can provide data communications via GPRS and/or EDGE. Additionally, or alternatively, the cellular network 602 can be configured as a 3G Universal Mobile Telecommunications System (“UMTS”) network and can provide data communications via the HSPA protocol family, for example, HSDPA, EUL, and HSPA+. The cellular network 602 also is compatible with 4G mobile communications standards such as LTE, 5G mobile communications standards, or the like, as well as evolved and future mobile standards. In some embodiments, the cellular network 602 is or includes the WAN 136 (as a WWAN)

The packet data network 604 includes various systems, devices, servers, computers, databases, and other devices in communication with one another, as is generally known. In some embodiments, the packet data network 604 is or includes one or more WI-FI networks, each of which can include one or more WI-FI access points, routers, switches, and other WI-FI network components. The packet data network 604 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 604 includes or is in communication with the Internet. The packet data network 604 can be or can include the PDN 138. The circuit switched network 606 includes various hardware and software for providing circuit switched communications. The circuit switched network 606 may include, or may be, what is often referred to as a plain old telephone system (“POTS”). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable devices 610 such as the user system 102, the other user system(s) 122, a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610.

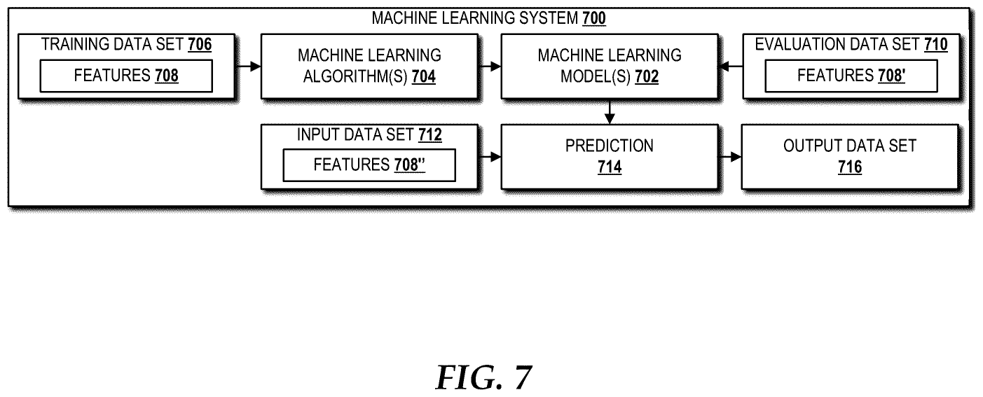

Turning now to FIG. 7, a machine learning system 700 capable of implementing aspects of the embodiments disclosed herein will be described. In some embodiments, aspects of the multi-modal communication module 106 can be enhanced through the use of machine learning and/or artificial intelligence applications. Accordingly, the user system 102 can include the machine learning system 700 or can be in communication with the machine learning system 700.

The illustrated machine learning system 700 includes one or more machine learning models 702. The machine learning models 702 can include supervised and/or semi-supervised learning models. The machine learning model(s) 702 can be created by the machine learning system 700 based upon one or more machine learning algorithms 704. The machine learning algorithm(s) 704 can be any existing, well-known algorithm, any proprietary algorithms, or any future machine learning algorithm. Some example machine learning algorithms 704 include, but are not limited to, neural networks, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 704 based upon the problem(s) to be solved by machine learning via the machine learning system 700.

The machine learning system 700 can control the creation of the machine learning models 702 via one or more training parameters. In some embodiments, the training parameters are selected modelers at the direction of an enterprise, for example. Alternatively, in some embodiments, the training parameters are automatically selected based upon data provided in one or more training data sets 706. The training parameters can include, for example, a learning rate, a model size, a number of training passes, data shuffling, regularization, and/or other training parameters known to those skilled in the art. The training data in the training data sets 706.

The learning rate is a training parameter defined by a constant value. The learning rate affects the speed at which the machine learning algorithm 704 converges to the optimal weights. The machine learning algorithm 704 can update the weights for every data example included in the training data set 706. The size of an update is controlled by the learning rate. A learning rate that is too high might prevent the machine learning algorithm 704 from converging to the optimal weights. A learning rate that is too low might result in the machine learning algorithm 704 requiring multiple training passes to converge to the optimal weights.

The model size is regulated by the number of input features (“features”) 708 in the training data set 706. A greater the number of features 708 yields a greater number of possible patterns that can be determined from the training data set 706. The model size should be selected to balance the resources (e.g., compute, memory, storage, etc.) needed for training and the predictive power of the resultant machine learning model 702.

The number of training passes indicates the number of training passes that the machine learning algorithm 704 makes over the training data set 706 during the training process. The number of training passes can be adjusted based, for example, on the size of the training data set 706, with larger training data sets being exposed to fewer training passes in consideration of time and/or resource utilization. The effectiveness of the resultant machine learning model 702 can be increased by multiple training passes.

Data shuffling is a training parameter designed to prevent the machine learning algorithm 704 from reaching false optimal weights due to the order in which data contained in the training data set 706 is processed. For example, data provided in rows and columns might be analyzed first row, second row, third row, etc., and thus an optimal weight might be obtained well before a full range of data has been considered. By data shuffling, the data contained in the training data set 706 can be analyzed more thoroughly and mitigate bias in the resultant machine learning model 702.

Regularization is a training parameter that helps to prevent the machine learning model 702 from memorizing training data from the training data set 706. In other words, the machine learning model 702 fits the training data set 706, but the predictive performance of the machine learning model 702 is not acceptable. Regularization helps the machine learning system 700 avoid this overfitting/memorization problem by adjusting extreme weight values of the features 708. For example, a feature that has a small weight value relative to the weight values of the other features in the training data set 706 can be adjusted to zero.

The machine learning system 700 can determine model accuracy after training by using one or more evaluation data sets 710 containing the same features 708′ as the features 708 in the training data set 706. This also prevents the machine learning model 702 from simply memorizing the data contained in the training data set 706. The number of evaluation passes made by the machine learning system 700 can be regulated by a target model accuracy that, when reached, ends the evaluation process and the machine learning model 702 is considered ready for deployment.

After deployment, the machine learning model 702 can perform a prediction operation (“prediction”) 714 with an input data set 712 having the same features 708″ as the features 708 in the training data set 706 and the features 708′ of the evaluation data set 710. The results of the prediction 714 are included in an output data set 716 consisting of predicted data. The machine learning model 702 can perform other operations, such as regression, classification, and others. As such, the example illustrated in FIG. 7 should not be construed as being limiting in any way.

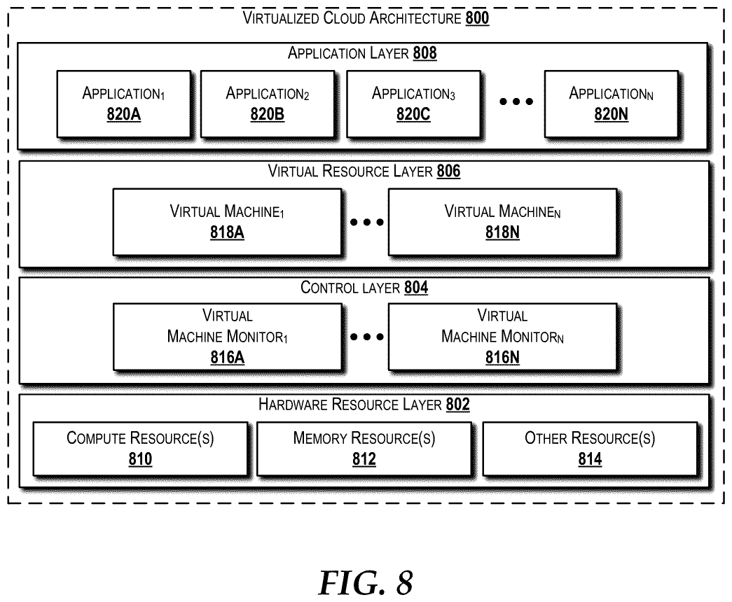

Turning now to FIG. 8, a block diagram illustrating an example virtualized cloud architecture 800 and components thereof will be described, according to an exemplary embodiment. The virtualized cloud architecture 800 can be utilized to implement various elements disclosed herein. In some embodiments, the communications service 112, at least in part, is implemented in the virtualized cloud architecture 800.

The virtualized cloud architecture 800 is a shared infrastructure that can support multiple services and network applications. The illustrated virtualized cloud architecture 800 includes a hardware resource layer 802, a control layer 804, a virtual resource layer 806, and an application layer 808 that work together to perform operations as will be described in detail herein.

The hardware resource layer 802 provides hardware resources, which, in the illustrated embodiment, include one or more compute resources 810, one or more memory resources 812, and one or more other resources 814. The compute resource(s) 810 can include one or more hardware components that perform computations to process data, and/or to execute computer-executable instructions of one or more application programs, operating systems, and/or other software. The compute resources 810 can include one or more central processing units (“CPUs”) configured with one or more processing cores. The compute resources 810 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 810 can include one or more discrete GPUs. In some other embodiments, the compute resources 810 can include CPU and GPU components that are configured in accordance with a co-processing CPU/GPU computing model, wherein the sequential part of an application executes on the CPU and the computationally-intensive part is accelerated by the GPU. The compute resources 810 can include one or more system-on-chip (“SoC”) components along with one or more other components, including, for example, one or more of the memory resources 812, and/or one or more of the other resources 814. In some embodiments, the compute resources 810 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 810 can be or can include one or more hardware components architected in accordance with an advanced reduced instruction set computing (“RISC”) machine (“ARM”) architecture, available for license from ARM HOLDINGS. Alternatively, the compute resources 810 can be or can include one or more hardware components architected in accordance with an x86 architecture, such an architecture available from INTEL CORPORATION of Mountain View, California, and others. Those skilled in the art will appreciate the implementation of the compute resources 810 can utilize various computation architectures, and as such, the compute resources 810 should not be construed as being limited to any particular computation architecture or combination of computation architectures, including those explicitly disclosed herein.

The memory resource(s) 812 can include one or more hardware components that perform storage operations, including temporary or permanent storage operations. In some embodiments, the memory resource(s) 812 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 810.

The other resource(s) 814 can include any other hardware resources that can be utilized by the compute resources(s) 810 and/or the memory resource(s) 812 to perform operations described herein. The other resource(s) 814 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 802 can be virtualized by one or more virtual machine monitors (“VMMs”) 816A-816N (also known as “hypervisors”; hereinafter “VMMs 816”) operating within the control layer 804 to manage one or more virtual resources that reside in the virtual resource layer 806. The VMMs 816 can be or can include software, firmware, and/or hardware that alone or in combination with other software, firmware, and/or hardware, manages one or more virtual resources operating within the virtual resource layer 806.

The virtual resources operating within the virtual resource layer 806 can include abstractions of at least a portion of the compute resources 810, the memory resources 812, the other resources 814, or any combination thereof. These abstractions are referred to herein as virtual machines (“VMs”). In the illustrated embodiment, the virtual resource layer 806 includes VMs 818A-818N (hereinafter “VMs 818”). Each of the VMs 818 can execute one or more applications 820A-820N in the application layer 808.

Based on the foregoing, it should be appreciated that aspects of need-based generation of multi-modal communication aids to aid verbal communications have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by a user system comprising a processor executing a multi-modal communication module, during a communications session hosted by a communications service and established between the user system and an additional user system, a request for a multi-modal communication aid to be used;
in response to the request, receiving, by the user system, a selection of the multi-modal communication aid; and
providing, by the user system, the multi-modal communication aid to the additional user system via the communications service.

2. The method of claim 1, wherein the communications session comprises live audio.

3. The method of claim 2, wherein the communications session further comprises live video; and wherein the multi-modal communication aid comprises an avatar-based visualization superimposed on the live video.

4. The method of claim 2, wherein receiving the request for the multi-modal communication aid comprises receiving the request for the multi-modal communication aid in response to a technology issue with the live audio experienced by a user associated with the additional user system during the communications session.

5. The method of claim 2, wherein receiving the request for the multi-modal communication aid comprises receiving the request for the multi-modal communication aid in response to a user issue with the live audio experienced by a user associated with the additional user system during the communications session.

6. The method of claim 1, wherein in response to the request, receiving the selection of the multi-modal communication aid comprises, in response to the request, receiving the selection of the multi-modal communication aid based upon a pre-defined multi-modal communication aid.

7. The method of claim 1, wherein in response to the request, receiving the selection of the multi-modal communication aid comprises, in response to the request, receiving the selection of the multi-modal communication aid based upon a new multi-modal communication aid created, on-the-fly, by a user associated with the user system.

8. The method of claim 1, wherein in response to the request, receiving the selection of the multi-modal communication aid comprises, in response to the request, receiving the selection of the multi-modal communication aid based upon a new multi-modal communication aid created based upon an artificial intelligence decision made by the multi-modal communication module.

9. A method comprising:
sending, by a user system comprising a processor executing a multi-modal communication module, during a communications session hosted by a communications service and established between the user system and an additional user system, a request for a multi-modal communication aid to be used;
in response to the request, receiving, by the user system, the multi-modal communication aid; and
presenting, by the user system, the multi-modal communication aid to a user associated with the user system.

10. The method of claim 9, wherein the communications session comprises live audio.

11. The method of claim 10, wherein the communications session further comprises live video; and wherein the multi-modal communication aid comprises an avatar-based visualization superimposed on the live video.

12. The method of claim 10, wherein sending the request for the multi-modal communication aid comprises sending the request for the multi-modal communication aid in response to a technology issue with the live audio experienced by a user associated with the user system during the communications session.

13. The method of claim 10, wherein sending the request for the multi-modal communication aid comprises sending the request for the multi-modal communication aid in response to a user issue with the live audio experienced by a user associated with the user system during the communications session.

14. The method of claim 9, further comprising generating, by the user system, the request based upon a profile.

15. The method of claim 14, wherein the profile comprises a trigger word.

16. A user system comprising:
a processor; and
a memory comprising instructions including a multi-modal communication module that, when executed by the processor, cause the processor to perform operations comprising
receiving, during a communications session hosted by a communications service and established between the user system and an additional user system, a request for a multi-modal communication aid to be used,
in response to the request, receiving a selection of the multi-modal communication aid, and
providing the multi-modal communication aid to the additional user system via the communications service.

17. The user system of claim 16, wherein receiving the request for the multi-modal communication aid comprises receiving the request for the multi-modal communication aid in response to a technology issue with a live audio experienced by a user associated with the additional user system during the communications session.

18. The user system of claim 16, wherein receiving the request for the multi-modal communication aid comprises receiving the request for the multi-modal communication aid in response to a user issue with a live audio experienced by a user associated with the additional user system during the communications session.

19. The user system of claim 16, wherein in response to the request, receiving the selection of the multi-modal communication aid comprises, in response to the request, receiving the selection of the multi-modal communication aid based upon a pre-defined multi-modal communication aid.

20. The user system of claim 16, wherein in response to the request, receiving the selection of the multi-modal communication aid comprises, in response to the request, receiving the selection of the multi-modal communication aid based upon a new multi-modal communication aid created based upon an artificial intelligence decision made by the multi-modal communication module.
